(19) United States
(12) Patent Application Publication
(10) Pub. No.: US 2015/0003706 A1
(43) Pub. Date: Jan. 1, 2015

(54) PROBABILITY MAPPING FOR VISUALISATION AND ANALYSIS OF BIOMEDICAL IMAGES

(71) Applicants: UNIVERSITY OF STAVANGER, Stavanger (NO); STAVANGER UNIVERSITY HOSPITAL, Stavanger (NO)

(72) Inventors: Trygve Eftestøl, Sandnes (NO); Leik Woie, Stavanger (NO); Kjersti Engan, Stavanger (NO); Lasya Priya Kotu, Stavanger (NO); Stein Ørn, Stavanger (NO)

(21) Appl. No.: 14/364,811

(22) PCT Filed: Dec. 12, 2012
(86) PCT No.: PCT/GB2012/053110

§ 371 Date: Jun. 12, 2014

(30) Foreign Application Priority Data
Dec. 12, 2011 (GB) 1121307.1

(51) Int. Cl. G06K 9/00; G06T 7/40; G06T 7/00; G06T 15/20

(52) U.S. Cl. CPC G06K 9/00523; G06T 15/20; G06K 9/00201; G06T 7/40; G06T 7/0079; G06T 2200/04; G06T 2207/10072; G06T 2207/20112; G06T 2207/30048
USPC 382/131

(57) ABSTRACT

The invention provides a method of image transformation of a biomedical image, said method comprising: for each voxel of said biomedical image, calculating a transform value indicative of the likelihood of that voxel representing a first tissue type (such as scar tissue); wherein calculating said transform value includes: applying at least one feature function to calculate at least one feature value from the original image voxel value for said voxel and/or from the original image voxel values of one or more voxels proximate to said voxel, said feature function or functions being capable of discriminating between said first tissue and a second tissue type (e.g. healthy tissue); and deriving said transform value from said one or more feature values. The method allows more detail to be extracted from images about the locations of scar and healthy tissue and thus facilitates diagnosis. The transformed image can also be segmented to identify particular areas of interest such as the border zone between scar and healthy tissue where the two tissue types are interwoven. The segmentation technique better identifies clinically relevant information within the image. This information can then be processed to provide an indicator of clinical significance.

The invention relates to imaging techniques for visualisation of biomedical images such as of the myocardium, in particular for identifying, visualising and analysing certain segments of the image which are useful medical indicators or are useful in making certain diagnoses. For example, the method can be applied to images where normal and affected tissue can be identified in a biomedical image. The transform will emphasize the difference between the two tissue types and the transition areas between the two tissue types.

The World Health Organization (WHO) estimates that more then 17 million people die of cardiovascular diseases (CVDs) every year. It is one of the leading causes of death in the developed world accounting for around 30% of all deaths. By 2030 it is estimated that almost 23.6 million people will die annually from heart disease and stroke. It remains a tremendous medical and cost burden on society. As the population ages, the incidence and prevalence of CVD increases and the need for early detection and intervention will be exacerbated. In addition, non-invasive diagnostic imaging provides cardiologists with detailed anatomical (e.g. CT, MRI, US), metabolic and functional (e.g. nuclear imaging, fMRI) information upon which an accurate diagnosis can be made. Currently no single imaging test is superior to all the others and a variety of imaging modalities may be used to diagnose or monitor CVD.

Patients who have suffered but survived one heart attack—myocardial infarction—may subsequently suffer a possibly disabling or fatal cardiac arrhythmia.

Biomedical imaging of the heart of a patient who has had a myocardial infarction can enable the muscle regions with reduced blood flow (scar tissue) to be identified and its location and extent to be mapped and determined.

After a myocardial infarction, the damaged tissue forms a scar. This scar tissue is more fibrous and has other tissue components compared with healthy myocardial tissue. The size and location, amongst other factors, of the scar tissue can be used as a predictor of likelihood and possibly as a timescale indicator of future cardiac arrhythmias or other cardiac events. Hence it is useful to be able to map the scar tissue accurately. Moreover, the scar tissue can be divided into a core region of fibrous tissue and a border zone where the fibrous tissue interleaves with healthy myocardial tissue. This border zone is also believed to be a useful predictor of future arrhythmias and therefore it is particularly desirable to map the location and extent of the scar border zone (peri-infarct region). The border of large core scar areas is not always the only region of mixed/interleaved tissue. Mixed/interleaved tissue regions can be more widely distributed, e.g. in small areas of minor scarring. The extent of these mixed/interleaved tissue regions defines a cardiac segment which is a useful predictor of future arrhythmias and is therefore of diagnostic importance. It is therefore desirable to map such a segment.

There are a number of different methods of mapping the scar tissue and defining the border between healthy tissue and scar tissue. For example, the border may be defined by a cardiologist examining the cardiac image(s). For faster processing, automated methods can be used to segment the scar tissue from the healthy tissue. This is typically done by identifying a range of imaging signal intensities which correspond to the scar tissue and using thresholds to segregate the healthy from the damaged tissue. In recent years the problem of defining the gray zone (border zone or peri-infarct region) between healthy and dead tissue in the myocardium has received increased focus. The existing methods of mapping the border zone also use signal intensity statistics directly to determine the regions of interest. In other words, the classification of a given pixel as either border zone or not border zone is based on the received signal intensity corresponding to that pixel from the imaging apparatus.

At present, no generally accepted methods for definition of different cardiac segments exist. Scar may be manually demarked or the border may be identified as a percentage of the maximum signal intensity in the picture or normal remote region. The border between different segments has been correlated with histological studies, but the use of LGE-CMR has limitations due to problems of data acquisition during LGE-CMR imaging and partial volume effect. Also small variances of signal intensity in different segments may be overlooked. Due to lack of standardization of criteria for definitions of cardiac segments, relatively few comparative studies and costly and time consuming examinations of both image acquisition and segmentations of cardiac segments, it is highly desirable to have a better automatic method for analysis of the images. Myocardial scar may also be the results of virus or toxic substances or it may have unknown etiology. These scars are usually multiple and difficult to quantify with existing techniques.

GB 2416944 describes the use of probability mapping techniques for classifying voxels as corresponding to a tissue type of interest based on user-selected positive and negative examples.

GB 2478329 describes another probability mapping technique for identifying different tissue types, specifically for identifying polyps in the colon. The technique is used to detect objects of interest and also mentions that labelled regions can be determined by thresholding the probability map.

Neither of these prior art references teaches the use of probability mapping for identifying image segments which are to be use for further image processing. They also do not relate to the identification of border zone or mixed/interleaved tissue regions.

According to a first aspect, the invention provides a method of image transformation of a biomedical image, said method comprising: for each voxel of said biomedical image, calculating a transform value indicative of the likelihood of that voxel representing a first tissue type; wherein calculating said transform value includes: applying at least one feature function to calculate at least one feature value from the original image voxel value for said voxel and/or from the original image voxel values of one or more voxels proximate to said voxel, said feature function or functions being capable of discriminating between said first tissue type and a second tissue type; and deriving said transform value from said one or more feature values.

Under this image transformation, the original imaging data is transformed into a new representation which can more easily be visualised and which allows easier identification and/or extraction of certain characteristics of the original image data. In other words, the transform mapping offers enhanced visualization showing details with physiological significance difficult to see or not visible in the original biomedical image.

For example, the transform mapping of the myocardium is a useful tool to study different cardiac segments with different discriminative properties and their relationship to various diagnoses, therapy options or prognosis. The discriminative properties of the image may be image texture. It is beneficial to study the heterogeneous nature of cardiac segments and their relationship to various diagnoses, therapy options and prognosis. Examples of applications are: Identification and quantification of the risk of serious arrhythmias and a better indication for the implantation of defibrillators (ICDs); prediction of the expected heart rate of ventricular tachycardia; identification of risk and degree of heart failure; indication of implantation of pacemakers in order to synchronize cardiac contractions (CRT-device); indication for bypass or heart transplantation; and indication of damage of the autonomic nervous system of the heart. Also the structure of different segments (i.e. texture) of the heart can be explored in relation to diagnosis, therapy and prognosis. The use of the invention should facilitate better diagnoses and thus better medical treatments.

Biomedical images, although routinely presented like a two-dimensional digital photograph made up of a two-dimensional array of square picture elements (pixels), are in fact a computer construct from a data set which can be presented as a three-dimensional image made up of a three-dimensional array of volume elements (voxels), typically cubic volume elements or as any two-dimensional slice through the imaged region of the patient. In the method of the invention, two-dimensional images (slices) may be used, but equally the three-dimensional image may alternatively be used. If two-dimensional images are used, it is preferred that the results should be the average of a plurality of parallel slices, preferably 10 to 20.

The voxel data in a biomedical image is generally an intensity value, which can be plotted on a white-to-black grey scale corresponding to the signal (e.g. radio frequency signal) attributable to a corresponding element in the object or person being imaged. The voxel data however may alternatively be in the form of relaxation times and such data may also be used in the method of the invention. Biomedical image data may be stored in various formats. Each pixel/voxel may have many values associated with it, including original data and transformed data. Images may be produced by selecting and/or combining the image data.

Preferably the method further includes segmenting the image to extract an image segment of diagnostic importance by comparing the transform values of the voxels to one or more threshold values; and calculating a clinical indicator from voxel values of the voxels of the extracted image segment. Segmenting the image in this way produces a cardiac segment comprising a set of voxels which correspond to a range of probabilities in the probability map which are considered to be of diagnostic relevance. Using the probability map to identify the image segment provides a better image segment from a clinical point of view as it identifies with greater accuracy the voxels which contain information of clinical relevance. Image segments based on original image intensity values have been found to provide less relevant information. Once the image segment has been identified from the probability map, the set of voxels within that segment may be used as the basis for calculating a clinical indicator which can be used as a tool to determine future treatment. E.g. in the context of cardiac images, an indicator can be produced of the likelihood of future arrhythmias and thus of the need for an Implantable Cardioverter Defibrillator (ICD). The indicator is a calculation (i.e. a feature describing properties of the tissue in the region) based on the voxel values of the set of voxels in the identified image segment. The voxel values used in this calculation may be the original image intensity values and/or the probability values and/or intermediate values (e.g. feature values calculated for the voxels during generation of the probability map).

Preferably the step of calculating said clinical indicator comprises calculating a texture feature from said voxel values of said segmented voxels. A textural feature (e.g. the entropy of the identified voxels) provides a clinical indicator indicative of the texture of the tissue within the identified segment. This uses information that is more difficult (if not impossible) for a clinician to extract and/or evaluate by eye.

The invention may be applied for mapping relative likelihoods of any two tissue types. However, preferably the first tissue type is damaged tissue and the second tissue type is healthy tissue. Damaged tissue here is intended to include abnormal tissue or tissue which is otherwise not healthy, for example cancerous tissues. In some preferred embodiments, the first tissue type is scar tissue and the second tissue type is healthy tissue. Such embodiments are useful for assessing the level of damage which has occurred.

The invention provides a technique for representing a biomedical image (e.g. of the myocardium) as a probability map where high transform values indicate damaged tissue, low transform values indicate normal tissue and intermediate values indicate areas where damaged and healthy tissues are interwoven. This gives an instrument by which to define areas (segments) within the image (e.g. within the myocardium), which have diagnostic relevance for further analysis.

The values of the transformation preferably vary on a scale in which the extremes of the scale represent high and low probabilities. In other words the transform values may be related to probability values. For example high values may indicate high probability and low values may indicate low probability of tissue being of the first tissue type. Alternatively the scale could be the opposite way round (essentially indicating probability of being second tissue type). It should also be noted that the values may be normalised so that the transform values are probability values range between 0 and 1, but this is not always necessary. The transform values may be normalised to different values or they may be unnormalised. Probability values are preferred in some cases as the probability value can be readily interpreted.

A particular advantage of the invention is that the transform mapping has the ability to base the transformed representation (and thus subsequent area/segment definitions) on image information other than just the basic imaging signal information. For example, the representation may be based on signal intensity, textural and possibly other characteristics (frequency properties, shape characteristics, etc) individually or in combination. For example, the texture of a biomedical image might provide information related to for example the fibrous structure of muscles or the structure of blood vessels. Such features might be structured or random and have different strengths and orientations. Various texture measures exist or can be developed to quantify this information.

Many different textural features may be used, for example edge detection or co-occurence matrices for various voxel neighbour relationships. The number of neighbouring voxels to be taken into account (and thus the proximity of the neighbouring voxels) will depend on the scale of the expected texture, but typically adjoining voxels or voxels separated by no more than a few voxels are used.

The voxels which are proximate to the image voxel in question form the neighbourhood of that voxel and can be described as an image patch. Such arrays of voxels may be square or cubic arrays (e.g. an N×N×N cube) or may be circular or spherical (i.e. defined according to distance from the voxel in question) collections of voxels. Other pixel/voxel selections may of course be used depending on the circumstances.

The feature functions used in the invention may be based on such textural calculations or they may be functions of other features or just functions of the original image voxel data. The functions may also be based on other information which is available, e.g. comparisons with previous analyses or parameters input separately.

In particularly preferred embodiments, the feature functions are compared with data derived from a number of images which have previously been segmented into first/second tissue type (e.g. scarred/healthy tissue). Such image segmentation may have been done by a clinical expert, e.g. a cardiologist.

To establish whether or not a given feature function is suitable for distinguishing between first tissue (e.g. damaged tissue) and second tissue (e.g. healthy tissue), it is preferably tested on a trial database. The trial database may consist of a number of biomedical images in which each voxel is categorized as either first tissue (e.g. scar tissue) in the region of interest, second tissue (e.g. healthy tissue) in the region of interest or as being outside the region of interest. For example, an image of the heart may show regions of myocardial tissue, being regions of interest and also other non-myocardial tissue and/or blood within a heart chamber which are not directly of interest to the evaluation. A given feature function can then be tested against this database by calculating the feature function value for each voxel in the database (or at least every region of interest voxel in the database) and evaluating how well it distinguishes between voxels which have been classified as first tissue type and those classified as second tissue type.

One use of the invention is to identify myocardial scar due to myocardial infarction. However, the invention also facilities distinguishing myocardial scar caused by other means (e.g. virus, rejection after heart transplantation, toxic effects of cancer chemotherapeutica etc).

Additionally the invention is not restricted to myocardial images, but can also be used for analysis of any other tissues with different tissue properties, not necessarily fibrosis, but for example, different blood supply, bleeding, necrosis, inflammation, tumor metastasis etc. For example the invention can be used to identify tissue changes due to cancer of different organs, cerebral tissue changes due to infections, degeneration such as occurs with Alzheimer's disease, bleeding in different organs etc. The methods of the invention can be applied to the cases where normal and affected tissue can be identified in a biomedical image. The transform will emphasize the difference between the two types of tissue. The transform provides a discriminator of two types of tissues, but it goes beyond dichotomous discrimination as it also emphasizes transitions between the two types of tissue, such as areas of interleaving tissue types or other areas of diagnostic importance. The methods of the invention provide a tool for many studies such as identifying relationships between changes of texture from pathological tissue and histopathological findings, biochemical changes or clinical finding. Different feature functions may be needed for applying the invention to different tissues.

The term probability mapping is used in the rest of this document to mean transform mapping where the transform values are indicative of the likelihood of that voxel representing the first tissue type. As discussed above, these values of the probability map need not actually be probabilities.

One aim of preferred embodiments of the invention is to visualize the heterogeneous nature of scarred myocardium tissue through probability mapping. In these embodiments, in the probability map of scarred myocardium, each pixel/voxel is the posterior probability of the pixel being scar compared to healthy myocardium. The probability maps are calculated using Bayes rule using feature vectors. The feature vectors calculated for each pixel/voxel in the scarred myocardium are used to find the parameters in the posterior probability function. Different features can be used to generate probability maps, but in some preferred embodiments the features that have good discriminative power when comparing scarred and non-scarred myocardium are used. In other embodiments, features may be used which are not as good at discriminating between scar and non-scar tissue, but reveal or emphasize details not otherwise visible in the original image. Once the probability map has been calculated, it may be viewed as a whole by a cardiologist or other technician to analyse the data. However, to further aid the analysis and any further diagnosis, the image may be segmented based on the transformed image data. Preferably therefore the method further includes segmenting the image by comparing the transform value of the voxels to one or more threshold values. A single threshold may be used, e.g. taking all voxels with a transform value greater than a certain threshold will identify voxels with above a certain probability of being scar tissue. Similarly healthy tissue may be segmented by taking voxels with below a certain threshold value. The probability mapping may thus be used to automatically delineate scar tissue from healthy tissue. The segmentation of scar itself is an important application, for example in the case of myocardial scar, the scar size contains information useful for finding the patients with high and low risk of arrhythmia. Also, scar size is largely responsible in ventricular remodelling. However, one particularly preferred use of the invention is for identifying the region or regions in which the two types of tissue are mixed (e.g. border zone, peri-infarct region in the myocardium) or other areas of diagnostic importance. Preferably therefore the one or more threshold values delineate an image segment where the first tissue type is interleaved with the second tissue type (e.g. scar tissue is interleaved with healthy tissue) or carries some other diagnostically important characteristic. This interleaved segment (or other diagnostically important segment) may be defined by intermediate transform values. Selection of appropriate upper and lower thresholds allows variation of how the image segment is defined, thus allowing high control over the segmented area.

Accordingly, an interleaved tissue zone between first and second tissue types can be delineated based on the transform value. For example, where cancerous tissue can be distinguished from normal tissue based on a different blood vessel structure, the transform value could be used to identify an interleaved tissue zone (e.g. a border zone) between tumour tissue and healthy tissue.

Recent studies show that the heterogeneity of myocardium tissue after myocardial infarction is another major risk factor for the mortality of patients with reduced Left Ventricle Ejection Fraction (LVEF). In these studies, the scarred tissue is divided into core area and border area (also referred to as peri-infarct area, gray zone area). The myocardial muscle fibers are completely dead at the core area of the scar. The core area is thus not helping in contraction of the heart and will not react to the electrical signals that propagate through the heart to tell the muscles when to contract. At the border areas however, the muscle fibers are not all dead. The electrical signals will be disturbed in these areas possibly causing reentries and sometimes arrhythmias. The latter indicates that the border areas (i.e. interleaved tissue areas) are an important part (possibly the most important part) of the scar, and thus good ways of defining and visualizing these interleaved areas will be particularly beneficial in many situations.

It will be appreciated that the definition of the interleaved tissue segment, i.e. the selection of the threshold values will depend on the purpose of the image transformation, e.g. the diagnosis which the image is to facilitate. It will be appreciated that the thresholds may be based on actual feature function values or they may be based on calculated probabilities.

The image transformation may be applied to the whole image. However, in general a biomedical image will contain regions of interest which are to be analysed and other regions which are of less direct relevance. For example in an image of the myocardium, the myocardium may appear as a ring of tissue with blood inside the ring and other tissues outside the ring. If it is only necessary to analyse the myocardial tissue then the image transformation need not be performed on the rest of the image. Instead the myocardium may be segmented from the rest of the image and the transformation may be applied only on the myocardium segment. Preferably therefore the method further comprises a step of delineating voxels which correspond to tissue of interest from voxels which correspond to other tissue or non-tissue. This segmentation may be done manually or automatically. As discussed above, this step may be done before the rest of the image transformation, thus reducing the processing that has to be done for the rest of the transformation, but the segmentation may equally well be done after processing. This may be useful if the transformation also assists with providing a better distinction between the tissue of interest (e.g. the myocardium) and its surroundings.

In preferred embodiments, the transform value is only calculated for the voxels identified as corresponding to tissue of interest. This saves processor resources as the voxels corresponding to tissue that is not of interest are not processed.

It will be appreciated that a number of different feature functions may be identified to produce a value which is indicative of the likelihood of a voxel representing scar tissue. However, in some preferred embodiments the feature function for a given voxel includes calculating the mean of the original voxel values in an image patch associated with that voxel. The feature value itself could be the mean of such voxel values (e.g. the mean of the received image signal intensities for each voxel) or it may involve further computation based on that calculated mean. For example, this feature value could be combined with one or more other feature values for said voxel.

Image patches can be defined in many different ways, for example squares or cubes around the given voxel, with varying sizes (e.g. side lengths) or they may be circular, i.e. defined by distance from the given voxel. The image patch could be centred on the voxel or could be off-centre. In preferred embodiments the image patch comprises the given voxel and the immediate neighbourhood of that voxel, i.e. the voxels which are adjacent to the voxel and optionally also further voxels adjacent to those voxels. For example in a 3×3 square image patch centred on a voxel, the immediate neighbourhood would comprise the 8 voxels surrounding it (in a 2 dimensional image) and a 5×5 and 7×7 image patch would further comprise the 16 voxels surrounding those and the 24 voxels surrounding those respectively. The skilled person will appreciate that many such image patch definitions may be used and will be selected according to the circumstances.

As described above, in some preferred embodiments the image patch is a square or cube with a side length of 3 voxels.

The feature function for a given voxel may be based on the texture of an image patch associated with that voxel. Texture can be defined in different ways, but one way is to view the voxel values as a sequence of discrete signal values. Texture represents the variations in an image, e.g. high or low frequency variations across one or more dimensions and/or the size of granularities, etc.

The feature value for a given voxel may be calculated based on a comparison of said image patch associated with said voxel with a dictionary representation of said image patch by a dictionary trained on either the first tissue type (e.g. scar tissue) or the second tissue type (e.g. healthy tissue). A dictionary is a collection of atoms which can be combined together with different weights to form a representation (which could be exact, but is normally an approximation) of an original. Using a dictionary which has been trained on a certain tissue type (i.e. which contains atoms which can be used to represent textures corresponding to that tissue type), the comparison will yield better results when the image patch contains texture corresponding to that tissue type. Therefore a better match indicates more likelihood of the given voxel representing that tissue type.

In preferred embodiments, the feature value is based on the difference between said image patch and said dictionary representation of said image patch. The difference may take the form of an image residual or representation error, i.e. comparing how good a match has been achieved by the dictionary representation. For example, the representation error may be taken as a norm of the original image patch minus the dictionary representation of the image patch.

The comparison may be made on just one trained dictionary. However, preferably the feature value is based on a comparison of said image patch associated with said voxel with two dictionary representations of said image patch, the two dictionary representations being a first dictionary representation by a first dictionary trained on the first tissue type and a second dictionary representation by a second dictionary trained on the second tissue type. With such a dual comparison, the image patch may produce a good match with either dictionary (indicating high or low probability of being scar tissue) or it may not compare well to either dictionary (indicating neither scar nor healthy tissue, but instead perhaps indicating a mixture of scar and healthy tissue). One might also train a dictionary specifically for representing a cardiac segment. The dictionary training can be combined with optimization towards discriminating between patient groups according to some diagnostic criterion.

The quality of match with the two dictionaries may be combined in a number of ways to produce the feature value associated with a given voxel, but in particularly preferred embodiments, the feature value is based on a ratio of the representation error in one of the first and second dictionary representations to the sum of the representation errors in the first and second dictionary representations. It is particularly preferred to use the ratio of the representation error for healthy tissue to the sum of the representation errors as this will produce a low value when there is a good match (low error) with the healthy tissue dictionary, i.e. indicating low probability of being scar tissue.

In preferred embodiments the dictionary representations are sparse representations. This allows efficient selection of dictionary atoms.

As described above, the transform value may be a probability value in the range of 0 to 1, but may simply be a value indicative of the probability, i.e. of the likelihood of a voxel representing the first tissue type. However, in preferred embodiments, the transform value is a probability value. More preferably it is calculated according to Bayes rule using probability density functions for the feature value in both first tissue and second tissue and a prior probability of a pixel being of the first tissue type. Such a calculation will yield an actual probability value and thus allows easier interpretation of the results by the clinician. The prior probability and the probability density functions may be calculated from a database of images where the voxels have previously been classified into first tissue type and second tissue type. Such a database may be a collection of pre-analysed images where a cardiologist has segmented the images according to his/her assessment of scar tissue and healthy tissue. A simple prior probability may be taken as the number of voxels classified as scar tissue as a proportion of the total number of voxels in the database. The probability density functions may be determined by calculating the feature function for each voxel in the database and then estimating the parameters of the probability density functions for each of the two categories (e.g. scar and healthy tissue). Alternatively a non-parametric approach may be used.

The invention may apply to any type of tissue where scarring can occur, or indeed to the identification of different tissue types with different characteristics. In some embodiments, the biomedical image is a cardiac image. However the invention can also be applied in other scenarios as described above, e.g. to images of the brain where damage has resulted in scarring or the tissue damage has caused tissue changes characteristically different from normal tissue. Likewise, the invention may be used to assess other organs where scarring or fibrosis occurs, such as in the brain. The invention is not limited as to the tissue types that can be assessed and evaluated by probability mapping.

The invention also extends to a software product comprising instructions which when executed by a computer cause the computer to carry out any of the above-described methods. The software product may be a physical data carrier. The software product may comprise signals transmitted from a remote location.

The invention also extends to a method of manufacturing a software product which is in the form of a physical data carrier, comprising storing on the data carrier instructions which when executed by a computer cause the computer to carry out any of the above-described methods.

The invention also extends to a method of providing a software product to a remote location by means of transmitting data to a computer at that remote location, the data comprising instructions which when executed by the computer cause the computer to carry out any of the above-described methods.

The transformed image representation may be passed directly to a further analysis process or technique or it may be stored for future use. The transformed image may be displayed on a screen or printed out for evaluation and/or diagnostic purposes. The method therefore preferably further comprises a step of outputting a representation of the biomedical image in which each voxel is represented by its calculated transform value. The outputted image may of course include any segmented areas. The outputted image may comprise solely the segmented areas, or it may have these areas or their boundaries highlighted on the rest of the probability map data or on the original image data. One might also store the cardiac segment information electronically which can then be used for further analysis. This information might include all information related to that pixel/voxel position such as the intensity values, the feature values, the transform (probability) values etc. The skilled person will appreciate that many such data representations may be created according to the intended use or the preferences of the technicians who will analyse the images.

Any imaging technique which provides image data capable of distinguishing the first and second tissue types, (e.g. healthy and damaged tissue) may be used. Preferred embodiments of the invention use MRI data due to its widespread use and the benefits of imaging with non-ionizing radiation. However other imaging techniques such as CT, including fast CT such as multi-detector CT (MDCT) and Ultrasound may also be used. Different feature functions may be required for different imaging techniques.

According to a further aspect, the invention provides an image transformation system comprising: a memory arranged to store at least one feature function and a biomedical image; and a processor arranged to calculate, for each voxel of said biomedical image, a transform value indicative of the likelihood of that voxel representing a first tissue type; wherein calculating said transform value includes: applying said at least one feature function to calculate at least one feature value from the original image voxel value for said voxel and/or from the original image voxel values of one or more voxels proximate to said voxel, said feature function or functions being capable of discriminating between said first tissue type and a second tissue type; and deriving said transform value from said one or more feature values.

It will be appreciated that all of the preferred features discussed above relate equally to the method, software and apparatus.

Certain preferred embodiments of the invention will now be described by way of example only, and with reference to the accompanying drawings in which:

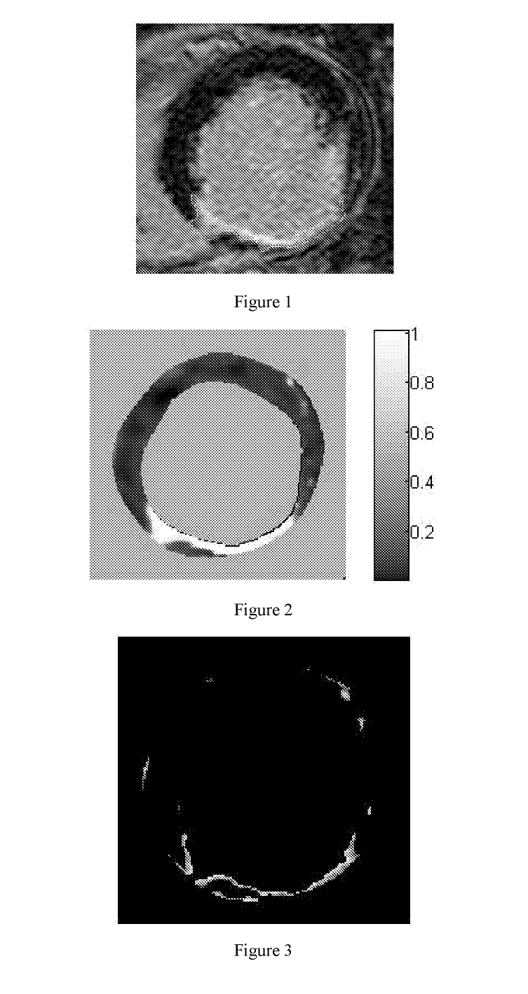

FIG. 1 shows a cropped short-axis cardiac magnetic resonance (CMR) image showing the heart muscle (myocardium) of one of the heart chambers with manual segmentation of scar tissues;

FIG. 2 shows a probability map according to the invention calculated from the image of FIG. 1;

FIG. 3 shows a cardiac segment of the myocardium of FIG. 1 corresponding to a probability range of 0.2-0.9;

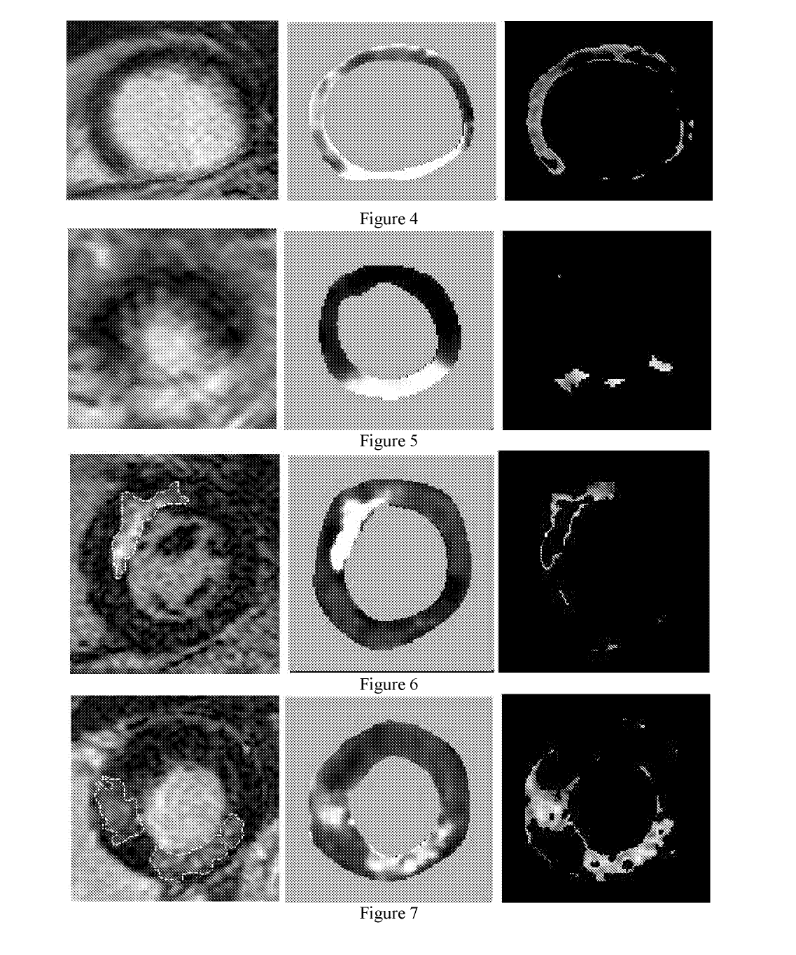

FIGS. 4 and 5 show CMR images with corresponding probability maps and cardiac segments corresponding to FIGS. 1 to 3 of patients with high risk of arrhythmias;

FIGS. 6 and 7 show CMR images with corresponding probability maps and cardiac segments corresponding to FIGS. 1 to 3 of patients with low risk of arrhythmias;

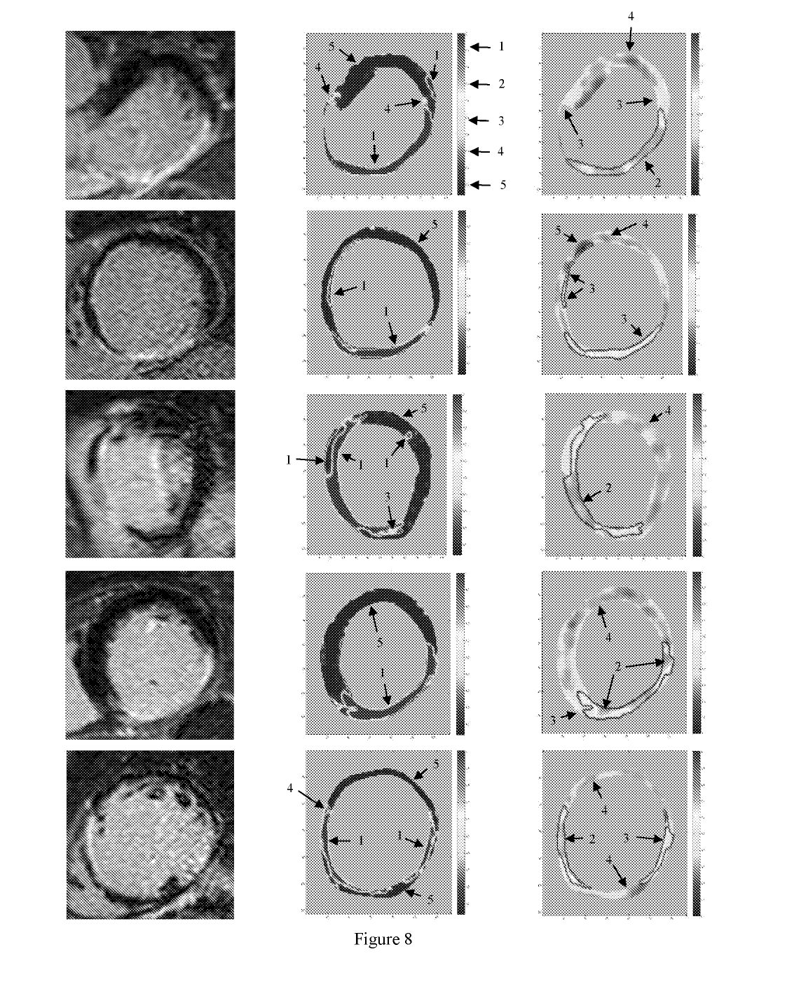

FIG. 8 shows CMR images and probability maps derived from different feature functions;

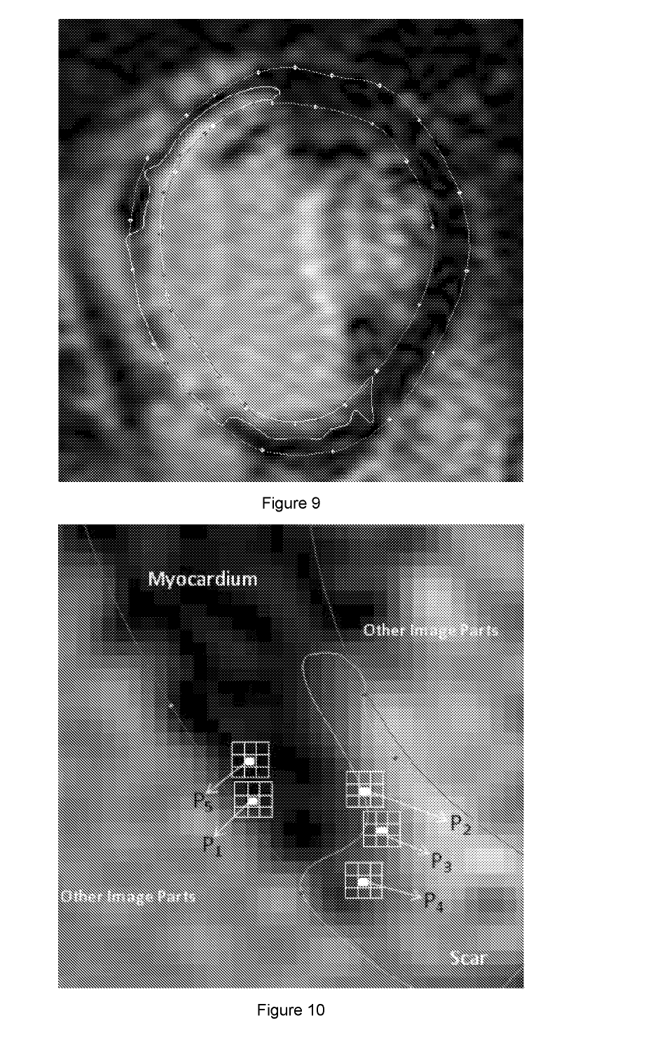

FIG. 9 shows a CMR image showing manual segmentation of myocardium and scar tissues;

FIG. 10 illustrates the selection of training vectors based on the location of the neighbourhood with respect to texture regions;

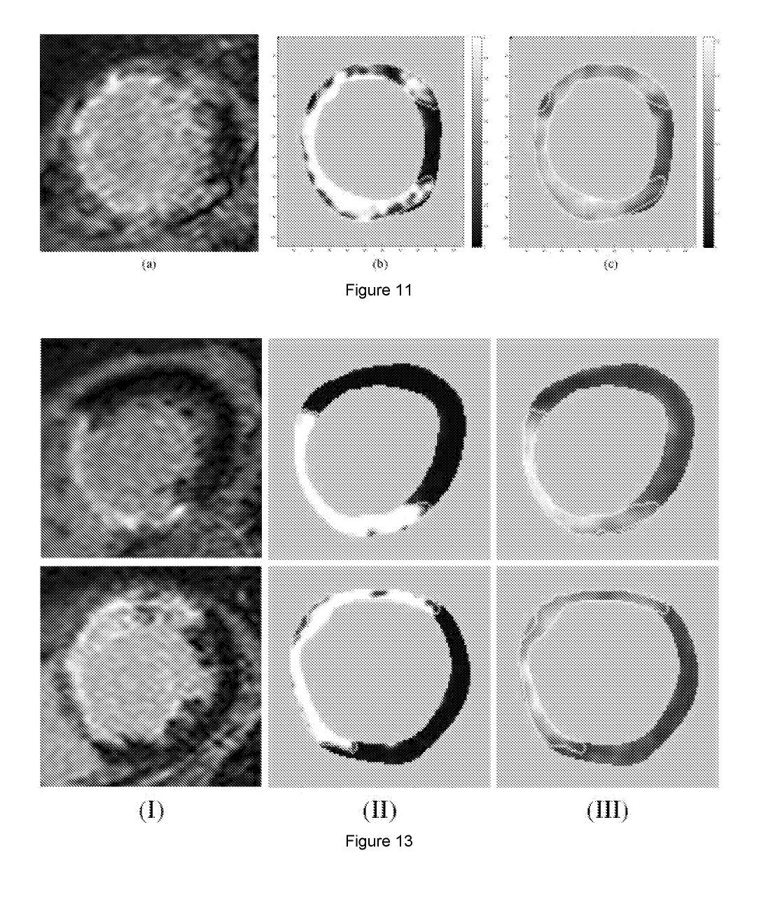

FIG. 11 shows probability maps of scarred myocardium in CMR images of patients implanted with an ICD using DC and texture features;

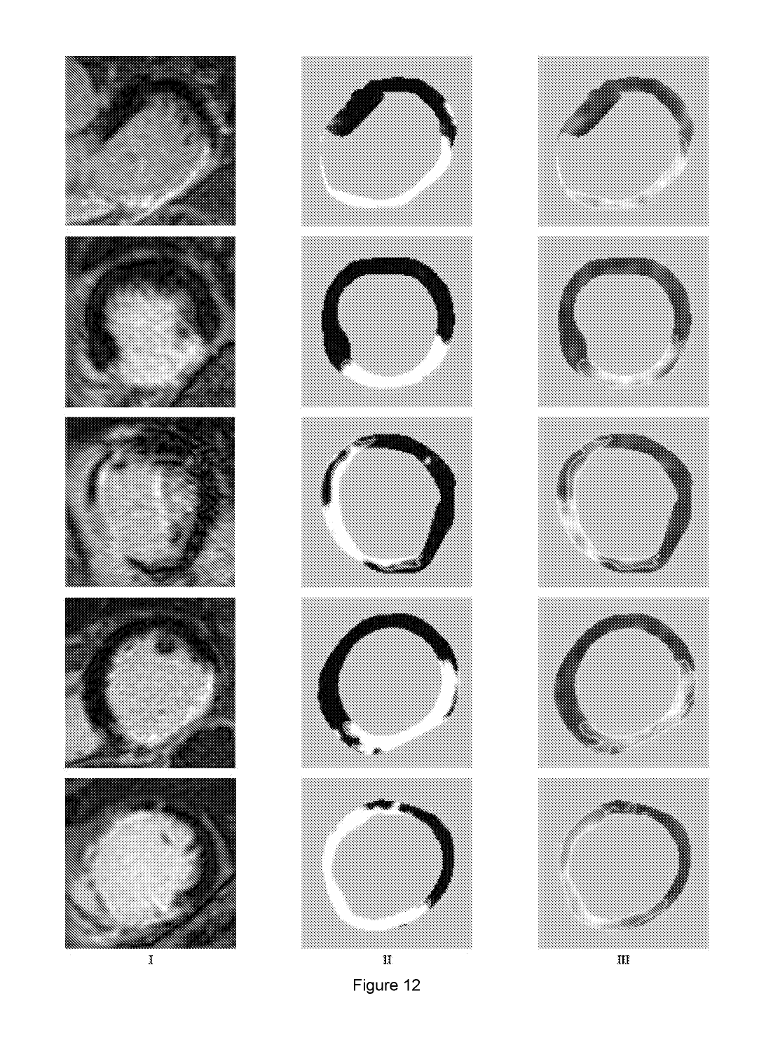

FIG. 12 shows probability maps of scarred myocardium in CMR images of 5 patients implanted with ICD using DC and texture features;

FIG. 13 shows probability maps of scarred myocardium in CMR images of patients without an ICD using DC and texture features;

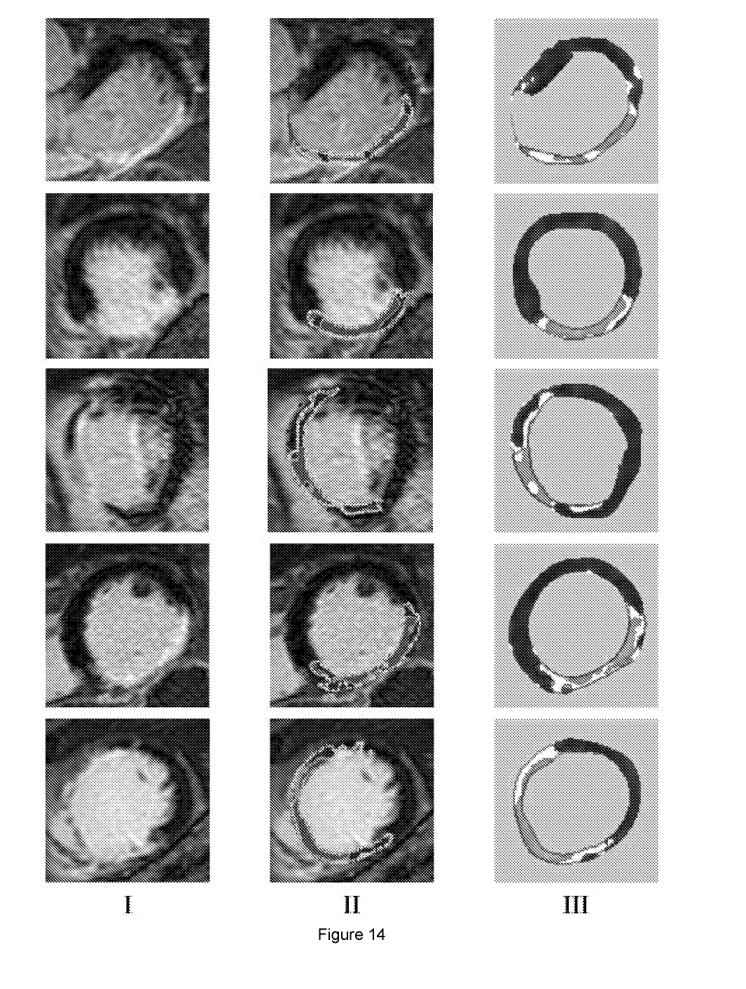

FIG. 14 shows the images of FIG. 12 alongside probability maps and identified cardiac segments;

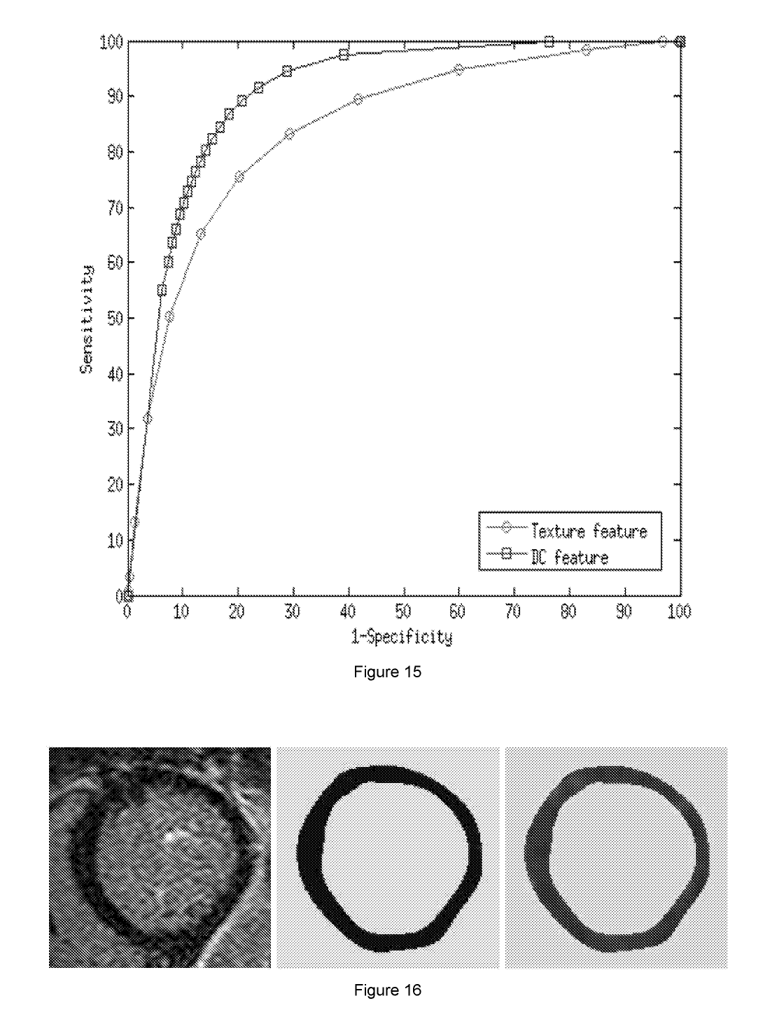

FIG. 15 shows ROC curves for DC and texture features;

FIG. 16 shows probability maps of an unscarred myocardium in CMR images of patients with ICD using DC and texture features; and

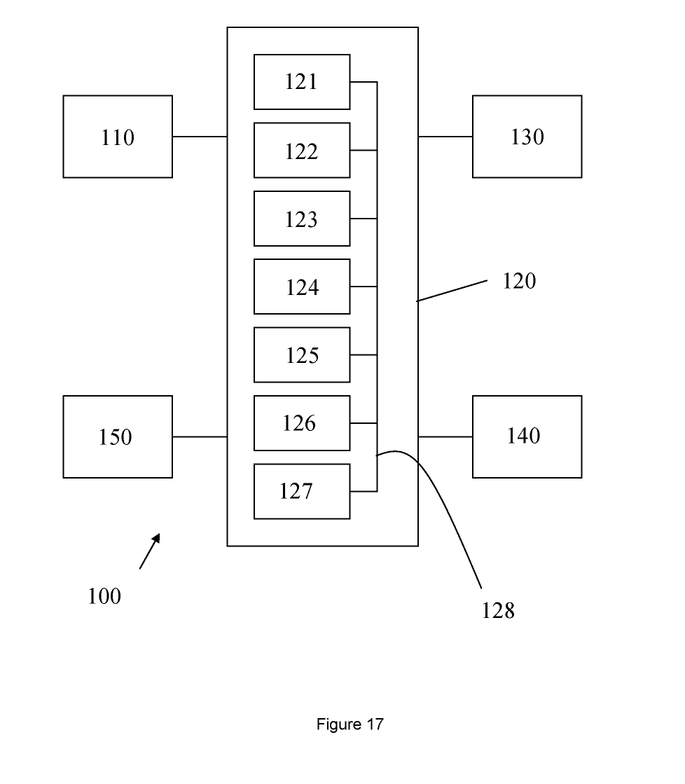

FIG. 17 schematically shows an apparatus for carrying out the invention.

The following description is of preferred embodiments of the invention that transform the intensity values in the pixel positions in a biomedical image of the myocardium into another image where the mapped value in a specific pixel position indicates the probability or likelihood that the corresponding tissue area in the imaged myocardium is damaged. The resulting image which will be referred to as a probability map offers a new way of visualizing and analyzing the myocardium.

In the following, a preferred image transformation method is described. The method for first deriving and applying the probability function (i.e. the transform function) is described followed by the method of applying the probability function to images to produce a probability map. The following stages are discussed:

1) The acquisition of biomedical images of the myocardium and the delineation of the scar and the myocardium to form a development image set.

2) The organization of the data into two sets representing the damaged and the non-damaged part of the myocardium respectively.

3) Deriving features from the data sets evaluated as to their ability to discriminate between the two data sets.

4) Deriving estimates of the probability density and prior probability functions for both damaged and non damaged myocardium for a discriminative feature vector and using Bayes rule to derive the posterior probability function which will be referred to as “the probability function”.

5) Applying the probability function to a biomedical image to calculate the corresponding probability mapping.

The calculation of the probability map in this embodiment is based on a probability function, an image and boundaries indicating the inner and outer myocardium upon which the function can be applied to produce a probability map. The boundaries are used to reduce the required processing by restricting this to the region of interest. However, in other embodiments, the whole image may be processed, i.e. predefined boundaries are not essential to the invention.

### Development Image Set

For the development of the probability function, a set of images of the myocardium is required. Each image comprises an array (typically three dimensional, but can also be a two dimensional slice) of voxels (or pixels in 2D). The original image data is typically an intensity value on a white-to-black grey scale corresponding to the signal (e.g. radio frequency signal) attributable to a corresponding volume element in the object or person or animal being imaged. The voxel data however may alternatively be in other forms such as relaxation times (e.g. in the case of MRI) and such data may also be used in the method of the invention. Each voxel in the data set corresponds to a volume within the imaged region. Several data values may be associated with each voxel, e.g. the original image data for that voxel as well as the transformed image data as well as any intermediate results such as the values of various feature functions used in the calculations. These data values may be scalar or vector values, or indeed more general tensor values.

To develop the probability function a development data set is first collected which consists of biomedical images from a number of patients with confirmed boundaries of both myocardium and scar tissue. Thus, in this set for all images in all slices in all patients, each pixel is labelled either as scarred myocardial tissue (also referred to as core of scar), as non-scarred myocardial tissue (also referred to as healthy tissue) or as not in the myocardial area. (It will be appreciated that in other embodiments, e.g. not relating to myocardial scar, each pixel/voxel is labelled as first tissue type, second tissue type, third tissue type, etc.)

The delineation of the myocardium and the scar tissue may be performed automatically, e.g. by the computer constructing the MR images, or manually, or automatically following initial operator identification of image zones corresponding to healthy myocardium and scar tissue. The boundary of the scar tissue may be identified for example as the edge of the healthy myocardium at which pixel intensity and/or homogeneity passes outside the normal range for the healthy myocardium. Operator feedback may be desirable to confirm boundary identification.

Next, for all voxels in the myocardium, a number of characteristic features are calculated from the available information in the image. A characteristic feature is a quantitative measure, which should be capable of discriminating between the tissues in the healthy myocardium and the core area of the scar. From a set of candidate features, the combination of features that best is able to discriminate between core of scar and healthy tissue is sought. Thus, for each image pixel in the development data set, a number of features x1, . . . , xd are calculated and combined into a feature vector x. The number of features, d, might be any number from one upwards. In one example, the feature vector might be one dimensional, with only one intensity based feature. Alternatively it might only consist of a single textural feature. One might also consider higher dimensional combinations of intensity based features, texture based features or both. All feature vectors calculated for pixels labelled as scarred myocardium are collected in the feature vector set specific for this category, denoted as Dscar. Correspondingly, all feature vectors calculated for pixels labelled as healthy myocardium are collected in Dmyo.

### Evaluating the Discriminative Ability of Feature Vectors

To evaluate the quality of a specific feature combination as a candidate for a probability mapping function, its ability to discriminate between healthy myocardium and scar tissue is measured (or more generally between first tissue type and second tissue type). For a specific feature combination, the ability to discriminate is evaluated through the area under the curve (AUC) of a receiver operator characteristics (ROC) curve determined from the specific feature combination vector calculated from Dscar and Dmyo. The ROC curve is plotted in a diagram where the true positive rate (TP) is shown on the vertical axis and one minus the true negative rate (TN) is shown on the horizontal axis. TP is the rate of correctly recognizing the scar tissue while TN is the rate of correctly recognizing the non scarred tissue. Loss functions are used to produce the different (TP,1-TN) coordinates.

In the process of calculating the AUC for a feature vector, x, the probability density functions (PDF) modelling specific feature combination vector values known to be located within scar or healthy myocardial areas are estimated as p(x|scar) and p(x|myo) respectively. p(x|scar) is estimated from the feature vectors in Dscar. One possible method of doing this, under the assumption of a Gaussian density function, is to estimate the parameters of the corresponding density function from Dscar according to the method of maximum likelihood. Similarly, the parameters for p(x|myo) can be estimated from Dmyo. Alternative methods for estimating PDFs can be used for improved accuracy if the assumption of normal distribution is not valid. In addition, prior probabilities expressing the proportions of the number of observed pixels being either scar or healthy myocardium are estimated as P(scar) and P(myo). P(scar) is estimated as the number of feature vectors in Dscar divided by the total number of feature vectors in Dscar and Dmyo. Similarly P(myo) is estimated as the number of feature vectors in Dmyo divided by the total number of feature vectors in Dscar and Dmyo. According to Bayes rule, the probability of a pixel being in the scar area can be calculated as P(scar|x)=(P(scar)p(x|scar))/p(x), where p(x)=P(scar)p(x|scar)+P(myo)p(x|myo). The prior probability describes our expectation of which state of nature an observation (feature vector calculated for a pixel position) will have before the observation is done. The PDFs correspond to the knowledge of how the values of the calculated features typically are distributed. Combining this knowledge, which is available prior to the observation with the information available in the observation using Bayes rule, the prior probability is transformed into the posterior probability, expressing the certainty of the state of nature after observation. A more intuitive way to illustrate the calculation of the posterior probability might be to consider a region, R, around the observed value of x. An estimate of the posterior probability might be considered by looking at the data from Dscar and Dmyo and counting the number of feature vectors n_{Rscar} and n_{Rmyo} found within R. An estimate can be formulated as:

P(scar|x)_{R}=n_{Rscar}/(n_{Rmyo}+n_{Rscar}).

For various feature combinations, the ability of each of these to discriminate between healthy and scarred myocardium is expressed through ROC analysis. High AUC values are used as indicators of which feature combinations are best suited to be used for the probability function which corresponds to P(scar|x). The skilled person will appreciate that this is just one method of assessing discriminative ability. Others may be used instead.

### Calculating the Probability Map for an Image

Once a feature combination, has been identified as well suited for use as an argument for the probability function, a probability mapping can be calculated for an image, preferably but not necessarily, with known myocardial boundaries. For this specific image, the feature combination vector x can be computed for every pixel in the segmented myocardium and the value of the probability function P(scar|x) can be computed for each of these pixels according to the equation given above. Thus, a new image can be constructed where in each pixel position, instead of the intensity values in the original image the corresponding probability value is used.

### Implementation of the Probability Mapping

A computer algorithm can be formulated and implemented in a computer or microprocessor based system. A biomedical image with the myocardium and optionally a mask image segmenting the myocardium is input to the computer program. The function expressions and parameters necessary for computing x and P(scar|x) are stored in memory. For each pixel, x and P(scar|x) are computed and stored in memory.

### Defining Cardiac Segments

A cardiac segment is a term introduced to describe a region of interest within the myocardium in the original biomedical image which might have diagnostic importance. In this embodiment, a cardiac segment is defined by a lower and upper probability so that the segment consist of all pixels with probability values in the range between these. The pixel positions of a cardiac segment are thus determined by subjecting each pixel in the probability map and including the pixel position in the cardiac segment if the probability value of the pixel is within the range specified by the lower and upper boundaries. For further analysis of a cardiac segment, the intensity values for all pixels in the segment can be taken or derived from the original biomedical image. Similarly, the probability values can be taken or derived from the probability mapping. Similarly other information derived from or related to that pixel position such as the feature values can be stored. The probability mapping offers a means to determine different cardiac segments accurately.

The border zone (BZ) discussed in more detail below is one example of a cardiac segment that needs an accurate definition and where several definitions exist. In the peri-infarct region (the border zone) there is an increased tissue heterogeneity with myocytes interleaved by fibrous tissue. The extent of the border zone, detected for example by LGE-CMR (Late Gadolinium Enhanced Cardiac Magnetic Resonance imaging), has been found to be a predictor of all-cause mortality after myocardial infarction (MI), and it is strongly associated with inducibility of ventricular tachycardia (VT). The border zone has previously only been arbitrarily defined on LGE-CMR images as myocardium with intermediate signal intensity enhancement between normal and scarred/fibrotic myocardium. This definition of the border zone therefore does not encompass a specific tissue characteristic.

The problems of defining a border zone is that the border between what is considered to be scar and healthy myocardium can be hard to decide accurately and objectively, and that the part of the myocardium that is a little bit damaged but not heavily damaged, can be an important area regarding arrhythmogenic behaviours. Thus, it is preferred that the border zone include a part outside but near the border defined by the core-scar segmentation. It is more preferred to identify all regions of interleaved scar/healthy tissue. In general it is desirable to identify all areas of diagnostic importance.

The results from preliminary experiments indicate that a cardiac segment based on a probability map as described above can be defined to represent the areas of diagnostic importance like the interleaved tissue areas (border zone). An accurate visualization of these regions can have a great impact in facilitating diagnosis. This embodiment provides a method for determining and using the areas of diagnostic importance (e.g. interleaved tissue regions) accurately by calculating features of clinical diagnostic relevance from areas in the myocardium specified to be within a specific range of probability values. For example The interleaved tissue region is determined as the range within which the clinical diagnostic features, possibly in combination with other established diagnostic features (like scar size), are best able to discriminate issues of clinical importance, e.g. the presence or future likelihood of ventricular arrhythmias.

As an example, one texture feature found to have clinical diagnostic relevance for indicating ICD implantation is the entropy of the original intensity values of the voxels in the area of diagnostic importance which could be an interleaved tissue segment. The combination of defining the image segment using a probability map to define the voxel set and the subsequent analysis of those voxels with a texture feature provides the clinically significant result.

Cardiac segments can also be used for establishing the scar boundaries automatically by defining a cardiac segment with upper boundary equal to a probability of one and the lower boundary set to act as the boundary between the healthy and the scarred myocardium.

### Visualization of Cardiac Segments in the Myocardium

The probability mappings generated as described above, offer enhanced visualization, showing details with physiological significance which are difficult to see or not visible in the original biomedical image.

FIG. 1 shows an example of an MR image and FIG. 2 shows the corresponding probability map calculated by applying the predefined probability function to the image of FIG. 1. In this specific example the method for calculating the features is based on textural representation of the scar and healthy tissues in infarcted heart muscle in combination with a feature capturing information about the intensity values in the neighbourhood around and including each pixel. This is therefore a two dimensional feature vector. Other features might be used instead, preferably the feature combination with the highest AUC value for discriminating scar from healthy myocardium. A dictionary is trained for representing the tissues of interest, one for the normal tissue and one for the scar tissue. These dictionaries are used in sparse representations of image patches, centered around each pixel in the region of interest in the MRIs. The representation errors are interpreted as textural features. Further to this, a feature based on the average intensity levels of each patch is computed. A classifier is trained to distinguish between the two tissues automatically using the explained features.

The probabilities shown in FIG. 2 go from 0-1 and are coded as shown in the adjacent bar. Scar with high probability is white and normal tissue black. The white dotted contour line in FIG. 1 shows the scar delineation made by the cardiologists from the original MRI. It can be seen that the probability mapping shows details that are not directly discernible in the original image. The mapping also makes it easier to define one or several cardiac segments. A cardiac segment can be defined by a lower and upper probability and consist of all pixels with probability values in the range between these (shades of gray). For further visualization, a color scheme giving a specific homogeneous color for each cardiac segment can be designed to emphasize cardiac segments of interest for a specific study objective.

FIG. 3 shows how cardiac segment can be defined to possibly represent a border zone segmentation performed on the probability map shown in FIG. 2. The segmentation is based on a probability range of 0.2-0.9 (probability boundaries were defined ad hoc to illustrate the concept), i.e. excluding tissue with high probability of being scar (i.e. the core-scar region) and excluding tissue with a high probability of being healthy myocardium. It can clearly be seen that the segmented tissue corresponds to regions around the border of the segmentation performed on the original MR image by the cardiologist (dotted line in FIG. 1), but additionally identifies other areas remote from the cardiologist's segmentation. The size of this border zone area (interleaved tissue region) would be very difficult if not impossible to identify and evaluate from the original MR image alone.

FIGS. 4, 5, 6 and 7 show further examples of the processing described above for different patients. In each case, the original MR image is shown on the left (with the cardiologist's segmentation shown in dotted line), the calculated probability mappings are shown in the middle and the border zone segmentation based on probability range 0.2-0.9 is shown on the right.

FIGS. 4 and 5 show patients with a high risk of arrhythmia and FIGS. 6 and 7 show patients with a low risk of arrhythmia.

FIG. 8 shows example probability maps of damaged myocardium in CMR images of patients implanted with ICDs. Two different probability maps are illustrated. One using a DC feature function (described in more detail in the examples below) and the other using a texture-based feature function (again described in more detail in the examples below). In FIG. 8, the lefthand column shows the cropped CMR images containing the left ventricle, the middle column shows probability maps of damaged myocardium using the DC value as a feature: In these images the colour coding is as follows: red-100%-80%, yellow-70%-60%, green-60%-50%, cyan-50%-30% and blue-20%-0% probability of being scar. Reference numbers 1, 2, 3, 4 and 5 are used in the figures to indicate areas of red, yellow, green, cyan and blue respectively. These are also indicated on one of the colour bars (all of which are identical). The white contour in the middle column shows the cardiologist's segmentation of scar. The righthand column shows probability maps of damaged myocardium using the texture feature. In these images, the colour coding is the same as in the middle column. The black contour in the righthand column shows the cardiologist's segmentation of scar.

This method makes it possible to study and characterize cardiac segments more objectively and with less use of time. It also makes it possible to initiate many studies to improve the diagnostic, therapeutic and prognostic value of LGE-CMR imaging as well as other imaging systems (e.g. CT or ultrasound). One application could be to combine the method with the imaging modality during electrophysiological arrhythmia ablation procedures in order to facilitate localization of region of interest. Because LGE-CMR is costly and time consuming during both acquisition and analysis, and with concern due to kidney function after contrast infusion, the Multi-detector CT (MDCT) may be an alternative method of image acquisition due to fast procedure and small radiation burden. The method described here is not dependent on the imaging method used and may also be useful with this and similar imaging methods, particularly ultrasound. There is also the possibility to better identify patients at various risks by investigating the relationship between different cardiac segments calculated and identified by this method and cardiac biomarkers, pharmacogenomics and genetic biomarkers to guide treatment decisions. The border zone is a potentially arrhythmogenic heterogeneous zone, and using the probability map as described above, arrhythmic risk may be evaluated by calculating features from voxels having probabilities within identified probability ranges. A recent study related textural measure in the border zone to different patient arrhythmia groups. The border zone in this study was determined using signal intensity statistic information only and thus defines a different cardiac segment.

Preliminary results from recent studies indicate that the intensity-based information alone has the best discriminative ability to distinguish between scar and myocardium while textural features alone have lower. This makes sense as the intensity based information was the visual available information that the cardiologist relied on to determine the boundaries between the healthy and scarred myocardium. These results indicate that probability maps based on only texture information will add features originating in structures not visible to the human eye in the original MRI. This is illustrated in FIG. 8 where the original images, mappings based on intensity based features alone and textural features alone are shown in columns I, II and III respectively. As can be seen, the intensity value based images in column II have a more clear cut distinction between high and low valued probability areas where the visible boundary seems to follow the boundary made by the cardiologist. The images in column III do not have a clear cut distinction between low and high probability ranges, but add more detail by mapping a larger part of the image into the intermediate probability range. Visibly, this gives the impression of adding more details.

Further exemplary embodiments of the invention will now be described in more detail.

Late Gadolinium (LG) enhanced Cardiac Magnetic resonance imaging (CMR) can be used for assessing morphology of the myocardium in patients after Myocardial Infarction (MI). Contrast agents used in CMR imaging increase the intensity of scarred tissue in the myocardium for better examination. FIG. 9 shows a cropped short-axis LG enhanced CMR image showing manual segmentation of myocardium and scar tissues by cardiologists. The dots in the image are manually marked (by the cardiologist) coordinates to segment myocardium and scar. The contours generated by cubic spline interpolations of the above coordinates show myocardium and scar tissues. The scarred myocardium has varying degree of functionality due to its heterogeneous nature.

In the following embodiments, probability maps are calculated using two different features. The mean intensity value over the neighbourhood of the pixel is used as one feature due to the obvious intensity differences between scarred and non-scarred myocardium in LG enhanced CMR images. This feature can be good in resembling the doctors' segmentation of scarred and non-scarred areas. The other feature used here is collected from the underlying texture information of the scarred myocardium. It has previously been shown that patients with high and low risk of getting arrhythmia can be classified using textural features as there are textural differences between the healthy myocardium and the scar tissues. In the following examples, dictionary learning techniques and sparse representation are used to find textural features of scarred myocardium. Examples of probability maps are obtained from the two features illustrating their potential use in identifying core and border area in the scarred myocardium.

### Calculation of Probability Maps Using Bayes Rule

To calculate the probability map, a probability function is developed. The probability function is obtained using Bayes rule. The class specific Probability Density Function (PDF) modelling specific feature vector values known to be located within scar or healthy myocardial areas are estimated as p(v|scar) and p(v|myo) respectively. In addition, prior probabilities expressing the proportions of the number of observed pixels being either scar or healthy myocardium are estimated as P(scar) and P(myo). According to Bayes rule, the probability of a pixel being in the scar area can be calculated as:

$$P ( scar \vert v ) = \frac{( P ( scar ) p ( v \vert scar ) )}{P ( v )} \qquad ( 1 )$$

where p(v)=P(scar)p(v|scar)+P(myo)p(v|myo) and v is a feature vector. The parameters in the class specific PDFs can be estimated using parametric or non-parametric methods. In these embodiments, the parameters in the class specific PDFs are calculated using the Maximum Likelihood (ML) estimation. The ML technique is a popular method for parametric estimation of an unknown probability density function (PDF). The ML estimates of the mean m_{ML} and the covariance matrix S_{ML} of normally distributed data V={v₁, v₂, . . . , vₜ, . . . , v_{N}} are given below:

$${m}_{ML} = \frac{1}{N} {\sum }_{i = 1}^{N} {v}_{t} and {S}_{ML} = \frac{1}{N} {\sum }_{i = 1}^{N} ( {v}_{t} - {m}_{ML} ) {( {v}_{t} - {m}_{ML} )}^{T} , \qquad ( 2 )$$

where N is the number of training feature vectors.

For a specific image, v can be computed for every pixel in the segmented myocardium and the value of P(scar|v) can be computed for each of these pixels according to equation (1) using class specific and prior probabilities. The parameters in class specific probabilities are obtained using ML estimation according to equation (2). There could be different ways of finding the features of the myocardium. The feature value v can be of any dimension and in these embodiments they are based on the mean intensity and the texture of each pixel in the myocardium. The extraction of feature vectors for the myocardium is illustrated in the following section of this document. Feature vector v of the myocardium in general can be represented as:

v=[feature₁, feature₂, . . . , featureₗ], (3)

where l is the dimension of feature vector v. Finally, the probability maps are obtained by regenerating a new image such that each pixel in the myocardium is represented by the value of P(scar|v). The probability values range from 0-1 and they may be displayed using a colour code. In one example, shades of red and yellow in the colour code represent high probability of scar and shades of green and blue represent less probability of being scar. Other colour maps may be used, or alternatively, grey-scale images may be produced.

### Extraction of Features

As discussed above, these embodiments use two features to generate probability maps of the scarred myocardium. The mean intensity value of image patches is used to obtain the DC feature. The texture feature is calculated using sparse representation by capturing the underlying texture information using dictionary learning techniques. DC-value dc(i, j) and dictionary based texture feature Rₚ(i, j) are the two features used to obtain the probability maps of scarred myocardium in these embodiments. Feature vectors v are represented as follows:

v=[dc(i,j)] and v=[Rₚ(i,j)]. (4)

These are each 1-dimensional feature vectors, but in other embodiments higher dimensional feature vectors may be used, e.g. 2-dimensional, 3-dimensional, n-dimensional. Higher dimensional feature vectors take into account more features of the image. Therefore higher dimensional feature vectors may have better discriminating capabilities, but will also most likely require greater processing.

The detailed process of extracting the two features are discussed in the following sub-sections A and B.

### A. DC Feature

In this embodiment we are looking at the capability of the dc-value of image patches for generating probability maps of scarred myocardium. Because of the obvious intensity differences in the healthy and scarred myocardium tissues in the LG enhanced CMR images, dc-value dc(i, j) has been used to find the probability maps. This is probably the feature that would mimic the cardiologists segmentation best, since the cardiologists also use the intensity values of scarred myocardium in CMR images to segment the scarred areas manually. We define the feature dc(i, j)=mean(I_{N×N}(i, j)) (where I_{N×N} is the array of intensities of pixels in the N×N square neighbourhood around the pixel (i, j)), such that a new image l_{dc}, with dc(i, j) as values at pixel position (i, j) is made as a sliding window averaging over the image. The DC feature is extracted as explained above in both training and test phases. The DC features calculated in the training phase are used to obtain the class specific and prior probabilities.

### B. Dictionary-Based Textural Feature

Sparse representations and learned dictionaries have been shown to work well for texture classification. Sparse representation of learned dictionary atoms reflects the typical texture present in the training set. For each pixel (i,j) in the myocardium, two textural features are calculated using dictionary learning and sparse representation. One is correlated with textural features of healthy myocardial region Rₘ(i, j) and the other one is correlated with textural features of scarred region Rₛ(i, j). In this embodiment, Recursive Least Squares Dictionary Learning Algorithm (RLS-DLA) presented in “Recursive least squares dictionary learning algorithm”, K. Skretting and K. Engan, Signal Processing, vol. 48. IEEE, 2010, pp. 2121-2130 is used for dictionary learning and the ORMP vector selection algorithm presented in “A fast orthogonal matching pursuit algorithm”, M. Gharavi-Alkhansari and T. Huang, Pro. ICASSP 1998. IEEE, May 1998, pp. 1389-1392 is used for sparse representation. It will be appreciated that other techniques may also be used.

### 1) Recursive Least Squares Dictionary Learning Algorithm:

A dictionary D, is an ensemble of a finite number of atoms and can be used to represent signals. A linear combination of some of the atoms in the dictionary gives exact or approximate representation of the original signal. Let a column vector x of finite length N represent the original signal. The dictionary atoms are arranged as columns in an N×K matrix D. The representation, or the approximation of the signal and the representation error can be expressed as:

$$\hat{x} = {\sum }_{k = 1}^{K} w ( k ) {d}^{( k )} = Dw , r = x - \hat{x} = x - Dw , \qquad ( 5 )$$

where d^{(k)} are the dictionary atoms and w(k) are the weighting coefficients.

Dictionary learning is the task of learning or training a dictionary on an available training set such that it adapts well to represent that specific class of signals. The training vectors and the sparse coefficients are arranged as columns in the matrices X and W respectively. The objective in dictionary learning is to give a sparse representation of the training set X in order to minimize the sum of the squared error. The cost function is formulated as:

$${argmin }_{D , W} F ( D , W ) = {argmin}_{D , W} {\sum }_{i} {‖ {r}_{i} ‖}_{2}^{2} . \qquad ( 6 )$$

The number of nonzero elements (sparseness) in each column of W is constrained.

This is a very hard optimization problem. The problem can be solved in a two step algorithm: Step 1) Find W using vector selection algorithms, keeping D fixed. Each column in w is given as

$${\hat{w}}_{i} = {argmin}_{w} {‖ {x}_{i} - {Dw}_{i} ‖}_{2} subject to {‖ w ‖}_{0} \leq s . \qquad ( 7 )$$

Step 2) Keeping W fixed, find D. The dictionary update step depends on the dictionary learning method we choose to use. The MOD (Method of Optimal Directions) algorithm (e.g. “Method of optimal directions for frame design”, K. Engan et al in Proc. ICASSP '99, Phoenix, USA, March 1999, pp. 2443-2446), the dictionary update step is D=(XW^{T})(WW^{T})⁻¹, i.e. the least squares solution. The MOD algorithm has the following drawbacks: 1) Convergence of the method depends on the selection of the initial dictionary. 2) fewer training vectors may result in over-training while a large number takes a large execution time.

The RLS-DLA algorithm referenced above is an on-line dictionary learning algorithm that addresses the above problems. It updates the dictionary with the arrival of each new training vector. In deriving updating rules for RLS-DLA, we define Xₜ=[x₁, x₂, . . . , xₜ] of size N×t, Wₜ=[w₁, w₂, . . . , wₜ] of size K×t and Cₜ=(WₜWₜ^{T})⁻¹ for the ‘time step’ t. At each time step the dictionary Dₜ₋₁ and the C matrix are updated so that they obey the least squares solution Dₜ=(XₜWₜ^{T})(WₜWₜ^{T})⁻¹. The matrix inversion lemma (Woodbury matrix identity) is applied on Cᵣ to get the following update rules:

Cₜ=Cₜ₋₁−αuu^{T}, (8)

Dₜ=Dₜ₋₁−αrₜu^{T}, (9)

where u=Cₜ₋₁wₜ and α=1/(1+wₜ^{T}u), and rₜ=xₜ=Dₜ₋₁wₜ is the approximation error.

With the inclusion of an adaptive forgetting factor A, in RLS-DLA, the update equation (8) is changed to:

Cₜ=(λₜ⁻¹Cₜ₋₁)−αuu^{T}, (10)

where u=(λ₁⁻¹Cₜ₋₁)wₜ. The remaining equations remain the same. Due to introduction of the forgetting factor, RLS-DLA has good converging properties and is less dependent on the initial dictionary. RLS-DLA requires less training time due to updating dictionaries on-line.

### 2) Texture Feature Extraction Using Sparse Representation:

Texture in a small image patch can be modelled as a sparse linear combination of dictionary atoms. The algorithm for sparse representation in this embodiment proceeds as follows: Consider the myocardium in a CMR image l, that contains two texture classes: healthy and scarred myocardium. The training vector yₗ for each pixel in the training image is made from that specific pixel and its neighbourhood N×N. In the training set, each pixel is classified into a specified texture class. Then, the dictionaries Dₛ and Dₘ are trained for the predefined texture classes (scar and myocardium) using RLSDLA. Using the two trained dictionaries, each training vector yₗ is then represented sparsely using the ORMP vector selection algorithm referenced above. For the training set, the residual images Rₛ and Rₘ which are of same size as the original image are calculated for the two texture classes. For each pixel in the myocardium of a training image, the residuals (or representation errors) for the dictionaries Dₛ and Dₘ are calculated as:

Rₛ(i,j)=∥yₗ−Dₛwₗ^{s}∥ and Rₘ(i,j)=∥yₗ−Dₘwₗ^{m}∥, (11)

where wₗ^{s} and wₗ^{m} are sparse coefficient vectors.

The pixel gives less error or residual to the dictionary to which it belongs. Finally, the residuals Rₛ and Rₘ are combined to form the texture feature used in this embodiment. The texture feature is calculated as the ratio of the residual using Dₘ to the sum of the residuals using Dₛ and Dₘ. It is shown as follows:

Rₚ(i,j)=Rₘ(i,j)/(Rₛ(i,j)+Rₘ(i,j)). (12)

Pixel by pixel, the Rₚ value can be interpreted as the scaling of residuals Rₛ and Rₘ. Smaller values of Rₚ mean that the pixel is probably not scar (i.e. it is probably healthy myocardium) and larger values means that it is probably scar or border area. The texture feature Rₚ(i, j) from the training set is used to find the parameters in the probability function for obtaining the probability maps. The test feature vectors are collected from the test image set in the same way as training feature vectors. The residual images Rₛ and Rₘ for test images are calculated for Dₛ and Dₘ in the same way as the training images. Texture is defined as pattern of spatial distribution of gray levels. Texture is not pixel-by-pixel local except in the edge between two textures. Therefore some sort of smoothing may be done on the test residual images before calculating the probability maps. The test residual images Rₛ and Rₘ are smoothed using an a×a pixels separable Gaussian low pass filter with variance σ⁻² before calculating Rₚ.

### Experiments and Results

Using Bayes rule, experiments were performed to find probability maps of scarred myocardium in CMR images using DC and texture features. All experiments were carried out in MATLAB. The CMR images used in these experiment were provided by the Department of Cardiology in Stavanger University Hospital. The CMR images were obtained from patients with high risk and low risk of getting arrhythmia. More specifically, CMR images from a group of 24 patients with high risk of arrhythmia were used. These 24 patients with high risk of getting arrhythmia were implanted with an ICD. The CMR images from patients with low risk of arrhythmia and without ICD were used only for testing purposes. All the CMR images were obtained from a 1.5 Tesla MRI machine using the same protocol. These CMR images were stored according to the Digital imaging and communications in medicine (DICOM) format with 512×512 pixel resolution. The number of image slices with visible scar in each patient varies approximately from 5 to 12 depending on the size of scar and heart. Only short-axis image slices with visible scar were used in our experiments. The size of the scar varies from one slice to the other. As shown in FIG. 9, manual segmentation of the myocardium and infarction tissues were used to form the labelled training sets for the both tissues. Pre-processing of any kind was not used on the images.

In sub-sections A and B below, the processes of calculating the probability maps using DC and texture feature respectively are explained. Sub-section C then discusses the examples of probability maps obtained in our experiments. Sub-section D illustrates how probability mapping can be used to define cardiac segments of diagnostic importance. Sub-section E shows that probability mapping can be used for segmentation of scar and non-scarred myocardium.

a. Probability Maps Obtained Using DC Feature Dc(i, j)

In all CMR Images, only the myocardium segmented by cardiologists is taken into account. In the group of 24 patients, 6 patients were used for training and 18 patients were used for testing. Two sets of training vectors were generated from scar and healthy myocardium. The neighbourhood size 3×3 was used to form training vectors as explained above. The same neighbourhood size must be used while training and finding the DC images l_{dc}. The DC images obtained from the training images were used to form the training feature set. The parameters of the class specific PDFs: the mean and the standard deviation were found using ML estimation according to equation (1) using the training feature set. DC-values were scaled to have zero mean and unit variance before finding the ML estimates. The scaling coefficients from the training were stored to scale the test vectors. The probability maps of the scarred myocardium were calculated using Bayes rule as explained above. An example of a probability map obtained using DC feature with gray scale colour code is shown in the second column of FIG. 11.

FIG. 11 shows probability maps of scarred myocardium in CMR images of a patient implanted with ICD using DC and texture features. The lefthand column (a) shows the cropped CMR image containing left ventricle. The middle column (b) shows a probability map of scarred myocardium using the DC value as feature: The colour code indicates white 100%-90%, light gray 90%-60%, gray 60%-30% and black 30%-0% probability of being scar. The white contour shows the cardiologist's segmentation of scar. The righthand column (c) shows a probability map of scarred myocardium using the texture feature. The same colour code described above is used here. Again, the white contour shows the cardiologist's segmentation of scar.

### B. Probability Maps Obtained Using Texture Feature Rₚ(i, j)

The texture features are calculated using the same training and test set employed in finding the DC features. Two sets of training vectors were generated from scarred and non-scarred myocardium segmented by cardiologists. The training vector and test vectors were generated in the same way as in the DC feature experiment using the same neighbourhood size 3×3. Consider the pixels on the border zones, their neighbourhood extends into other regions that are not under consideration. If we use training vectors from border regions, then the dictionaries might learn the texture properties of other regions along with the texture properties they are intended to learn. So, the training vectors for the pixels whose neighbourhood spans other regions were not considered in our experiments. This is depicted in FIG. 10.

FIG. 10 shows that training vectors are generated from each pixel as long as that entire neighbourhood lies within one texture region. The neighbourhood of pixels P₁, P₂ and P₃ include more than one texture region, and the corresponding feature vectors are excluded from the training set. P₄ and P₅ have the entire neighbourhood within one texture region and hence the corresponding feature vector is included in that texture's training set.

After generating the training vectors from both areas, the dictionaries were learned using RLS-DLA as explained above. The dictionary size of 9×90 atoms was used in our experiments. The initial dictionaries were formed by randomly selecting 90 vectors of length 9 from the training sets. The forgetting factor is initialized to 0.995 and slowly increased towards 1 according to the exponential method described in the RLS-DLA paper referenced above. The sparsity s used in these experiments is two, i.e. we used two vectors from the dictionary to represent the original pixel.

After the training step, dictionaries were used on training and test images to obtain residual images. For each pixel in the myocardium of training images, probability of residual Rₚ(i, j) was found from residual images as explained above. The training feature set is then generated from the probability of residual values. The ML estimates of the labelled training vector set were determined according to equation (2). The test vector set in this experiment was calculated after smoothing (using low pass Gaussian filter with σ=5 and 9×9 window size) the test residual images. Using the ML estimates and Bayes rule, the probability maps for texture features of the scarred myocardium were obtained. An example of such a probability map with gray scale colour code is shown in the third column of FIG. 11.

C. Examples of Probability Maps Obtained from DC and Texture Feature

The second and third columns of FIG. 12 show more examples of probability maps of scarred myocardium using the DC dc(i, j) and texture Rₚ(i, j) features respectively.

FIG. 12 shows probability maps of scarred myocardium in CMR images of 5 patients implanted with ICD using DC and texture features. The lefthand column shows the cropped CMR images containing left ventricle. The middle column shows probability maps of scarred myocardium using DC value as the feature. The righthand column shows probability maps of scarred myocardium using the texture feature. The colour coding is the same as in FIG. 11.

FIG. 13 shows examples of probability maps of scarred myocardium for both DC and texture feature for patients without ICD. The cropped CMR images containing the left ventricle are shown in the lefthand column (I), the probability maps for DC and texture features are shown in the middle (II) and righthand (III) column respectively. The colour scale is the same as for FIG. 11. Though the parameters for the probability function are obtained from patient group implanted with ICD in this embodiment, the DC and texture feature Rₚ are able to produce probability maps for the patients with low risk of getting arrhythmia (i.e. patients without ICD) also. The probability values in the DC feature experiment vary from 0 to 1 whereas the probability values in the texture feature experiment vary from 0.1 to 0.7. In order to compare the probability maps obtained by the two methods, they are plotted with the same scale.

The probability maps calculated for the two features, DC and textural feature, give different information. The DC feature will give high probabilities of being scar to areas that are brighter in the CMR image, which mimics the way the cardiologist reads the MRI. The textural feature, on the other hand, gives information related to the heterogeneity or homogeneity of the myocardial tissue. This can be information that is difficult to discover by inspection with a human eye. From the experiments discussed here, it can now be understood that using the DC feature in the probability mapping performs well for segmentation of scar (identifying scar area). Using textural features in the probability mapping provides a tool for defining cardiac segments (like core area and border area) as well as identifying features that might be used to distinguish between different groups of patients, such as patients with high and low risk of getting arrhythmia.

### D. Defining Cardiac Segments

The probability maps obtained from DC and texture features can be used to find cardiac segments. A cardiac segment can be defined as a region of interest in the myocardium which has diagnostic importance. We will define a cardiac segment by a lower and upper probability so that the segment consists of all pixels with probability values in the range between these. The probability maps obtained from the texture feature have a greater edge in defining the cardiac segments in scarred myocardium when compared to the DC feature as it captures the underlying tissue information. The probability mapping offers a means to determine different cardiac segments accurately. The second column of FIG. 14 shows the images of cardiac segments at different probability ranges.

In FIG. 14, the lefthand column (I) shows cropped CMR images. These images correspond to the five patients used in FIG. 12. In the middle column (II), three cardiac segments of diagnostic importance are plotted on the original MR image. The cardiac segment plotted in dark gray has probability levels of 0.7-0.5 in the corresponding probability map calculated using Texture feature Rₚ. Similarly cardiac segments plotted in light gray and black (inside white contour) contain pixels with probability levels 0.5-0.45 and 0.45-0.35 in that corresponding probability map respectively. The righthand column (III) shows the probability maps obtained using Texture feature Rₚ and showing core, border zone and healthy myocardium. Gray represents core area (probability of 0.7-0.5). White represents the border zone (probability 0.5-0.35). Black represents healthy myocardium (probability 0.35-0). The black contour shows the cardiologist's segmentation of scar.

The cardiac segments obtained from probability mapping can be used to define core and border zone in scarred myocardium. As discussed above, defining the interleaved tissue region (or border zone) in scarred myocardium is very important to find patients with high and low risk of arrhythmia. So far there is no universally accepted definition of border zone in scarred myocardium. The probability mappings described here can be used to better define these regions. In particular, the extent of the interleaved tissue region and/or its degree of texture (i.e. a texture feature calculated from the pixels/voxels in the identified cardiac segment) can be connected to clinical “endpoints” such as death, arrhythmias, heart failures, viabilities etc or biochemical tests like BNP (B-type natriuretic peptide; used to test for heart failure), metalloproteinases, necrosis-factors etc. All the pixels in the probability map of scarred myocardium between the intermediate probability levels could be defined as interleaved tissue zone. In the probability maps calculated from the texture feature, probability value varies from 0.1 to 0.7. The cardiac segments with intermediate probability levels 0.5 to 0.35 in these probability maps is one possible definition of border zone. The third column of FIG. 14 shows the results of finding core and border zone in the probability maps acquired from texture feature Rₚ.

It will be appreciated that the above probability ranges illustrate the ability to segment the probability map into different segments. The actual ranges considered to segment regions of diagnostic importance will depend on the circumstances, e.g. on what tissue is being tested, the type of damage that has occurred, etc. The invention is therefore not limited to particular ranges.

### E. Segmentation of Scarred and Non-Scarred Myocardium

The DC and texture feature can be used for segmentation of scarred and non-scarred tissues which is an important application on its own. Bayes classifier was used to get the final segmentation results. The obtained segmentation results were compared to the manual segmentation to obtain Receiver Operating characteristic (ROC) curves. The ROC curves calculated using the DC and texture features are shown in FIG. 15 on CMR images of the 18 test patients with high risk of getting arrhythmia. The area under the curves is 0.9052 and 0.8428 for DC and texture features respectively. From these ROC curves, it is observed that the discriminative power of the DC feature is comparatively higher than that of the texture features. These segmentation results compare well to previous studies.

According to the preferred embodiments described above, a new technique has been provided for enhanced visualization of scarred myocardium in biomedical images, particularly in LG enhanced CMR images, using probability mapping. Using Bayes rule and ML estimation, the probability maps of scarred myocardium using DC and texture features were obtained from each pixel in the myocardium. The probability mapping calculated by either or both of the two features helps to visualize the heterogeneous nature of scarred myocardium that is not obvious to the human eye in the original CMR image. The probability values obtained from the DC features can be used for determining the scar size and they seem to reflect the way cardiologists perceive the scarred myocardium in CMR images. The probability maps from texture features gives information about the characteristics of myocardial tissue and thus emphasize information that is not easily recognized in the original CMR image. The probability maps calculated by the two features in this work identify the same scar areas (see for example FIG. 12). This gives the confidence that the two features gives relevant information about scarred and non-scarred myocardium.

As a further illustration, FIG. 16 shows probability maps of myocardium without scar in CMR images of patients with ICD using DC and texture features. The lefthand column shows cropped CMR images containing the left ventricle. The middle column shows a probability map of the myocardium without scar using DC value as the feature. The righthand column shows a probability map of the myocardium without scar using texture feature. The colour code is the same as for FIG. 11.

The probability mapping offers a means to determine different heterogeneities present in the myocardium. Further, using probability mapping, cardiac segments of diagnostic importance can be found. In particular, the definition of the border zone can be made using cardiac segments. In addition it is found through texture analysis that learned dictionaries are capable of capturing differences in the textures of scar and healthy myocardium with a limited database of CMR images. Using probability mapping, the segmentation of scarred and non-scarred myocardium tissue is obtained and the segmentation is comparable to the manual segmentation by experts.

As discussed above, one might consider alternatives to probability mapping. The features, x, might be used directly individually or in combination so that a mapping could be made with the feature values given directly in the pixel positions rather than the probability values. The fundamental property of the proposed method is that it exploits information that emphasizes the scar/no scar difference characteristics in the image, i.e. the feature or combination of features having typically different values for scar and no scar. The evaluation of the discriminative properties of the features can also be made by other means than using a classifier (e.g. by statistical testing). The probability mapping has nice properties in the sense that it is always in the range 0-1, but this is not essential to the invention. In general, a discriminative feature can be used directly. Alternatively a feature or set of features can be processed through a functional operator to produce the mapping value. Some examples are considered to illustrate: 1) The feature A may directly be used as an indicator: low values indicating no scar and high values indicating scar. 2) The feature B may also be directly used as an indicator: low values indicating scar and high values no scar. 3) If A and B have low correlation, A/B might be used. The skilled person will appreciate that many other examples and combinations can be used.

Also, as discussed earlier, although the examples given above are in relation to the myocardium, it will be appreciated by the skilled person that the invention also applies to transformation of other biomedical images, such as those of other organs, especially the brain and liver, which suffer scarring or fibrosis.

FIG. 17 schematically shows a system 100 suitable for carrying out the invention. An imaging apparatus (such as an MRI machine, CT machine, ultrasound apparatus, etc.) 110 is provided for acquiring biomedical images. The imaging apparatus 110 can acquire images for gathering the development image set as well as for acquiring images for transformation and evaluation. Imaging apparatus 110 is connected to computer 120 which in turn is connected to a visual display unit 130 (e.g. a monitor) and one or more input apparatuses 140 (e.g. mouse, keyboard, trackpad, touchscreen, etc.). Additionally the computer 120 is connected to a database 130 which may be used to store the development image set as well as any other data or parameters used in the processing.

Computer 120 comprises a Central Processing Unit 121, a Graphical Processing Unit 122, Random Access Memory 123, Hard Disk Drive 124, Network Interface Card 125 (which may be wired or wireless), Removable storage medium 126 (e.g. floppy disk drive, CD/DVD ROM drive, tape drive, etc.) and output ports 127 (e.g. serial, parallel, USB ports, etc.) for connection to other peripheral devices (e.g. other computers, printers, other input or output devices), all of which are interconnected via a system bus 128.

During operation, the CPU 121 and/or GPU 122 are used to execute a program which may be stored and/or loaded onto the computer and run to cause the processors to execute the program instructions to carry out the image transformation methods of the invention, such as described above.

1. A method of image transformation of a biomedical image, said method comprising:
for each voxel of said biomedical image, calculating a transform value indicative of the likelihood of that voxel representing a first tissue type;
wherein calculating said transform value includes:
applying at least one feature function to calculate at least one feature value from the original image voxel value for said voxel and/or from the original image voxel values of one or more voxels proximate to said voxel, said feature function or functions being capable of discriminating between said first tissue type and a second tissue type; and
deriving said transform value from said one or more feature values;
wherein the method further includes segmenting the image to extract an image segment of diagnostic importance by comparing the transform values of the voxels to one or more threshold values; and
calculating a clinical indicator from voxel values of the voxels of the extracted image segment.

2. A method as claimed in claim 1, wherein said first tissue type is damaged tissue and said second tissue type is healthy tissue.

3. A method as claimed in claim 2, wherein said first tissue type is scar tissue.

4. A method as claimed in claim 1, 2 or 3, wherein calculating said clinical indicator comprises calculating a texture feature from said voxel values of said segmented voxels.

5. A method as claimed in claim 4, wherein the one or more threshold values delineate a border zone where said first tissue type is interleaved with said second tissue type.

6. A method as claimed in claim 1, further comprising a step of delineating voxels which correspond to tissue of interest from voxels which correspond to other tissue or non-tissue.

7. A method as claimed in claim 6, wherein the probability value is only calculated for the voxels identified as corresponding to tissue of interest.

8. A method as claimed in claim 1, wherein the feature function for a given voxel includes calculating the mean of the original voxel values in an image patch associated with that voxel.

9. A method as claimed in claim 8, wherein the image patch comprises the given voxel and the immediate neighbourhood of that voxel.

10. A method as claimed in claim 1, wherein the feature function for a given voxel is based on the texture of an image patch associated with that voxel.

11. A method as claimed in claim 10, wherein the feature value for a given voxel is calculated based on a comparison of said image patch associated with said voxel with a dictionary representation of said image patch by a dictionary trained on either said first tissue type or said second tissue type.

12. A method as claimed in claim 11, wherein the feature value is based on the difference between said image patch and said dictionary representation of said image patch.

13. A method as claimed in claim 11, wherein the feature value is based on a comparison of said image patch associated with said voxel with two dictionary representations of said image patch being a first dictionary representation by a first dictionary trained on said first tissue type and a second dictionary representation by a second dictionary trained on said second tissue type.

14. A method as claimed in claim 13, wherein the feature value is based on a ratio of the representation error in one of the first and second representations to the sum of the representation errors in the first and second representations.

15. A method as claimed in claim 11, wherein said dictionary representations are sparse representations.

16. A method as claimed in claim 1, wherein the transform value is calculated according to Bayes rule using probability density functions for the feature value in both said first tissue and said second tissue and a prior probability of a voxel being of said second tissue.

17. A method as claimed in claim 16, wherein the prior probability and the probability density functions are calculated from a database of images where the voxels have previously been classified into first tissue and second tissue.

18. A method as claimed in claim 1, further comprising:
outputting a representation of the biomedical image in which each voxel is represented by its calculated transform value.

19. A method as claimed in claim 1, wherein the biomedical image is a cardiac image.

20. A software product, the product comprising a non-transitory computer-readable medium, in which program instructions are stored, which instructions, when executed by a computer cause the computer to carry out a method according to claim 1.

21-24. (canceled)

25. An image transformation system comprising:
a memory arranged to store at least one feature function and a biomedical image; and
a processor arranged to calculate, for each voxel of said biomedical image, a transform value indicative of the likelihood of that voxel representing a first tissue type;
wherein calculating said transform value includes:
applying said at least one feature function to calculate at least one feature value from the original image voxel value for said voxel and/or from the original image voxel values of one or more voxels proximate to said voxel, said feature function or functions being capable of discriminating between said first tissue type and a second tissue type; and
deriving said transform value from said one or more feature values.

26-28. (canceled)
